(19) United States
(12) Patent Application Publication
(10) Pub. No.: US 2025/0234395 A1
(43) Pub. Date: Jul. 17, 2025

(54) METHOD AND APPARATUS FOR COMMUNICATION SERVICES

(71) Applicant: Telefonaktiebolaget LM Ericsson (publ), Stockholm (SE)

(72) Inventor: Fengpei ZHANG, Guangdong (CN)

(21) Appl. No.: 18/855,916

(22) PCT Filed: Apr. 20, 2022
(86) PCT No.: PCT/CN2022/087948

§ 371 Date: Oct. 10, 2024

(51) Int. Cl. H04W 76/10; H04W 36/08; H04W 60/00

(52) U.S. Cl. CPC H04W 76/10; H04W 36/08; H04W 60/00

(57) ABSTRACT

Various embodiments of the present disclosure provide a method for communication services. The method which may be performed by a user equipment (UE) includes receiving edge related information transmitted by a server. The edge related information indicates an edge application server (EAS) which is serving or to serve another UE paired with the UE. In accordance with an exemplary embodiment, the method further includes establishing a connection with the EAS indicated by the edge related information.

### FIELD OF THE INVENTION

The present disclosure generally relates to communication networks, and more specifically, to a method and apparatus for communication services.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of data communication and equipment manufacturing technologies, various communication devices are designed and utilized to support diversified services. Recently, remote control technology is widely used in modern society and becoming more and more popular and broader, both in civilian and industry applications. A use case of the remote control technology is teleoperated driving (ToD) where the driving of a vehicle may be controlled remotely by an operator over a communication network. Similar use cases may comprise remote drone control, digital twin, etc. These use cases may require a pair of user equipments (UEs) such as a teleoperated vehicle and a control station to achieve non-line-of-sight communication with each other. Considering the diversity of communication environments and application scenarios, the support and maintenance of paired UEs communication may become more challenging.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In order to meet dramatically increasing communication requirements, one interesting option for networking technique development is to support edge computing. Edge computing as an evolution of cloud computing may bring applications hosting from centralized data centers down to the network edge, closer to consumers and the data generated by the applications, especially when latency and bandwidth efficiency are concerned. In a vehicle system based on edge computing, a vehicle served by an edge node may switch from the edge node to another edge node due to mobility of the vehicle. For a pair of UEs, e.g., a vehicle and a control station involved in ToD, they may need to communicate with the same edge application server (EAS) to exchange information, e.g., video data captured by the vehicle, driving commands provided by the control station, etc. However, the current edge computing system may only support service discovery and service continuity for a single UE. In this case, communication services between the paired UEs may not be maintained since the control station may not be connected to a proper EAS which is currently serving the vehicle, especially when the serving EAS of the vehicle changes during edge node switching. Therefore, it may be desirable to enhance service discovery and/or service continuity for paired UEs in the edge computing system.

Various exemplary embodiments of the present disclosure propose a solution for communication services, which can enable edge discovery and/or service continuity for paired UEs (e.g., a primary UE such as a teleoperated vehicle, and a secondary UE such as a control station, etc.) communication using edge computing technology.

According to a first aspect of the present disclosure, there is provided a method performed by a UE (e.g., a secondary UE). The method comprises: receiving edge related information transmitted by a server. The edge related information may indicate an EAS which is serving or to serve another UE (e.g., a primary UE) paired with the UE. In accordance with an exemplary embodiment, the method further comprises: establishing a connection with the EAS indicated by the edge related information.

In accordance with an exemplary embodiment, the edge related information may further indicate an edge platform (EP) associated with the EAS.

In accordance with an exemplary embodiment, the UE may be a control station, and the another UE may be a teleoperated vehicle.

In accordance with an exemplary embodiment, the server may be a central application server (CAS).

In accordance with an exemplary embodiment, the method according to the first aspect of the present disclosure may further comprise: transmitting a request for the edge related information to the CAS. The request may indicate the another UE.

In accordance with an exemplary embodiment, the edge related information may further indicate the another UE.

In accordance with an exemplary embodiment, the method according to the first aspect of the present disclosure may further comprise: transmitting a message to the CAS. The message may indicate that the edge related information is received by the UE.

In accordance with an exemplary embodiment, the server may be a source EAS of the UE and the another UE, and the EAS indicated by the edge related information may be a target EAS to which the UE and the another UE are to switch from the source EAS.

In accordance with an exemplary embodiment, the method according to the first aspect of the present disclosure may further comprise: receiving a notification transmitted by the source EAS. The notification may indicate status of application context relocation (ACR) of the UE and the another UE.

In accordance with an exemplary embodiment, the method according to the first aspect of the present disclosure may further comprise: using the established connection with the target EAS to communicate with the another UE, when the notification indicates that the ACR of the UE and the another UE is completed.

According to a second aspect of the present disclosure, there is provided an apparatus which may be implemented as a UE. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a UE. The apparatus may comprise a receiving unit and an establishing unit. In accordance with some exemplary embodiments, the receiving unit may be operable to carry out at least the receiving step of the method according to the first aspect of the present disclosure. The establishing unit may be operable to carry out at least the establishing step of the method according to the first aspect of the present disclosure.

According to a fifth aspect of the present disclosure, there is provided a method performed by a CAS. The method comprises: receiving edge related information from an EAS. The edge related information may indicate that the EAS is serving or to serve a UE (e.g., a primary UE). In accordance with an exemplary embodiment, the method further comprises: maintaining registration information of the UE according to the edge related information. The registration information of the UE may indicate a serving EAS of the UE.

In accordance with an exemplary embodiment, the edge related information may further indicate an EP associated with the EAS.

In accordance with an exemplary embodiment, maintaining the registration information of the UE according to the edge related information may comprise: generating the registration information of the UE according to the edge related information. The registration information may include a registration identifier (ID) of the UE.

In accordance with an exemplary embodiment, the method according to the fifth aspect of the present disclosure may further comprise: transmitting the registration ID of the UE to the EAS.

In accordance with an exemplary embodiment, the method according to the fifth aspect of the present disclosure may further comprise: pairing the UE and another UE (e.g., a secondary UE).

In accordance with an exemplary embodiment, the method according to the fifth aspect of the present disclosure may further comprise: transmitting pairing information to the EAS. The pairing information may indicate the UE and the another UE.

In accordance with an exemplary embodiment, the method according to the fifth aspect of the present disclosure may further comprise: transmitting the edge related information to another UE paired with the UE.

In accordance with an exemplary embodiment, the method according to the fifth aspect of the present disclosure may further comprise: receiving a request for the edge related information from the another UE. The request may indicate the UE.

In accordance with an exemplary embodiment, the edge related information may be transmitted to the another UE when the another UE is authorized by the CAS.

In accordance with an exemplary embodiment, the edge related information may further indicate the UE.

In accordance with an exemplary embodiment, the method according to the fifth aspect of the present disclosure may further comprise: receiving a message from the another UE. The message may indicate that the edge related information is received by the another UE.

In accordance with an exemplary embodiment, the EAS may be a target EAS to which the UE is to switch from a source EAS, and the edge related information received by the CAS may include a registration ID of the UE.

In accordance with an exemplary embodiment, maintaining the registration information of the UE according to the edge related information may comprise: updating the registration information of the UE by changing the serving EAS of the UE from the source EAS to the target EAS, according to the registration identifier of the UE.

In accordance with an exemplary embodiment, the method according to the fifth aspect of the present disclosure may further comprise: informing the EAS of the update of the registration information of the UE.

According to a sixth aspect of the present disclosure, there is provided an apparatus which may be implemented as a CAS. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a CAS. The apparatus may comprise a receiving unit and a maintaining unit. In accordance with some exemplary embodiments, the receiving unit may be operable to carry out at least the receiving step of the method according to the fifth aspect of the present disclosure. The maintaining unit may be operable to carry out at least the maintaining step of the method according to the fifth aspect of the present disclosure.

According to a ninth aspect of the present disclosure, there is provided a method performed by an EAS. The method comprises: transmitting edge related information to a CAS. The edge related information may indicate that the EAS is serving or to serve a UE (e.g., a primary UE). In accordance with an exemplary embodiment, the method further comprises: receiving information related to registration of the UE from the CAS.

In accordance with an exemplary embodiment, the edge related information may further indicate an EP associated with the EAS.

In accordance with an exemplary embodiment, the information related to the registration of the UE may include a registration ID of the UE.

In accordance with an exemplary embodiment, the method according to the ninth aspect of the present disclosure may further comprise: receiving pairing information from the CAS. The pairing information may indicate the UE and another UE (e.g., a secondary UE) paired with the UE.

In accordance with an exemplary embodiment, the EAS may be a target EAS to which the UE is to switch from a source EAS, and the edge related information transmitted to the CAS may include a registration ID of the UE.

In accordance with an exemplary embodiment, the method according to the ninth aspect of the present disclosure may further comprise: receiving application context of the UE and another UE (e.g., a secondary UE) paired with the UE from the source EAS. The application context may include the registration ID of the UE and/or pairing information which indicates the UE and the another UE.

In accordance with an exemplary embodiment, the information related to the registration of the UE may indicate that registration information of the UE at the CAS is updated by changing a serving EAS of the UE to the target EAS.

In accordance with an exemplary embodiment, the method according to the ninth aspect of the present disclosure may further comprise: establishing a connection with the another UE, so as to support communication between the UE and the another UE.

According to a tenth aspect of the present disclosure, there is provided an apparatus which may be implemented as an EAS. The apparatus may comprise one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as an EAS. The apparatus may comprise a transmitting unit and a receiving unit. In accordance with some exemplary embodiments, the transmitting unit may be operable to carry out at least the transmitting step of the method according to the ninth aspect of the present disclosure. The receiving unit may be operable to carry out at least the receiving step of the method according to the ninth aspect of the present disclosure.

According to a thirteenth aspect of the present disclosure, there is provided a method performed by an EAS. The method comprises: transmitting edge related information towards a UE (e.g., a secondary UE), when another UE (e.g., a primary UE) paired with the UE switches from the EAS to another EAS. The edge related information may indicate that the another EAS is serving or to serve the another UE. In accordance with an exemplary embodiment, the method further comprises: transferring application context of the UE and the another UE to the another EAS. The application context may include: a registration ID of the another UE, and/or pairing information which indicates the UE and the another UE.

In accordance with an exemplary embodiment, the edge related information may further indicate an EP associated with the another EAS.

In accordance with an exemplary embodiment, the registration ID of the another UE may be provided by a CAS when the another UE is registered to the CAS.

In accordance with an exemplary embodiment, the method according to the thirteenth aspect of the present disclosure may further comprise: transmitting a notification towards the UE. The notification may indicate status of ACR of the UE and the another UE.

According to a fourteenth aspect of the present disclosure, there is provided an apparatus which may be implemented as an EAS. The apparatus may comprise one or more processors and one or more memories storing computer program codes. The one or more memories and the computer program codes may be configured to, with the one or more processors, cause the apparatus at least to perform any step of the method according to the thirteenth aspect of the present disclosure.

According to a fifteenth aspect of the present disclosure, there is provided a computer-readable medium having computer program codes embodied thereon which, when executed on a computer, cause the computer to perform any step of the method according to the thirteenth aspect of the present disclosure.

According to a sixteenth aspect of the present disclosure, there is provided an apparatus which may be implemented as an EAS. The apparatus may comprise a transmitting unit and a transferring unit. In accordance with some exemplary embodiments, the transmitting unit may be operable to carry out at least the transmitting step of the method according to the thirteenth aspect of the present disclosure. The transferring unit may be operable to carry out at least the transferring step of the method according to the thirteenth aspect of the present disclosure.

According to various exemplary embodiments, a common EAS may be selected for a pair of UEs which may be required to cooperate with each other in some use cases such as ToD, remote drone control and digital twin, etc., so that communication services between the pair of UEs may be maintained with optimized end-to-end latency.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating an example of ToD according to an embodiment of the present disclosure;

FIG. 2A is a diagram illustrating an exemplary architecture of an edge computing system according to an embodiment of the present disclosure;

FIG. 2B is a diagram illustrating an exemplary architecture of paired UEs communication using edge according to an embodiment of the present disclosure;

FIG. 3 is a diagram illustrating an exemplary edge discovery procedure according to an embodiment of the present disclosure;

FIG. 4 is a diagram illustrating an exemplary ACR procedure according to an embodiment of the present disclosure;

FIGS. 5A-5D are flowcharts illustrating various methods according to some embodiments of the present disclosure;

FIG. 6 is a block diagram illustrating an apparatus according to an embodiment of the present disclosure; and

FIG. 7A-7D are block diagrams illustrating various apparatus according to some embodiments of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

In recent years, a vehicle is becoming more and more intelligent, and it can communicate with any other entity that can offer rich functionalities to customers, such as multi-media experience, more safety experience, more smart navigation experience, etc. The development of vehicle technology makes it possible to control vehicles in various novel ways. Teleoperated driving (ToD) is the remote-controlled driving of a vehicle by an operator from outside line of sight.

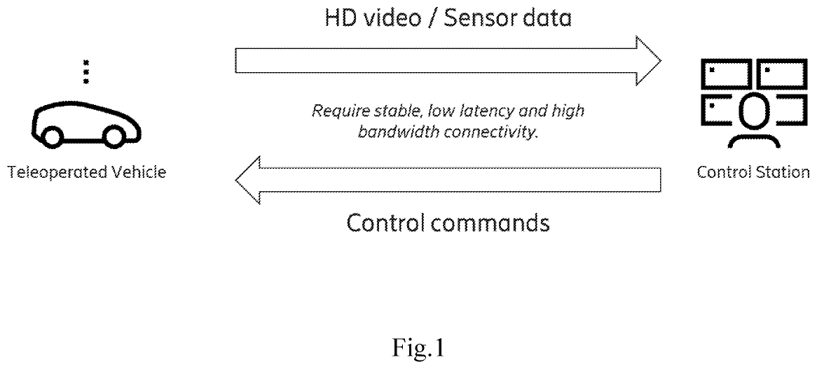

FIG. 1 is a diagram illustrating an example of ToD according to an embodiment of the present disclosure. Basically, ToD may require components such as high definition (HD) cameras, an on-board control unit in a vehicle, and a control center from which an operator can control the vehicle. The on-board unit in the vehicle may provide functions such as braking, accelerating, steering, etc., that the operator can access through a control station in the control center. In return, the on-board unit may provide the operator with data for a current visual impression of the road situation so that the operator can react appropriately. In order to create this current impression, the vehicle may need video streams from at least four HD cameras. These video streams may be delivered to the control center, e.g., via a mobile communication network on monitors or virtual reality (VR) glasses. According to the video streams and/or sensor data from the vehicle, the operator may send one or more control commands to the vehicle, e.g., via the mobile communication network. Stable, low latency and high bandwidth mobile connectivity may be one of important factors to enable ToD.

Edge computing may play an important role in the transformation of the telecommunications business, where telecommunications networks are turning into versatile service platforms for industry and other specific customer segments. This transformation may be supported by edge computing, as it opens the network edge for applications and services, including those from third parties. Due to the connectivity requirements on stability, latency and bandwidth, edge computing may be a perfect technology to enable ToD.

Mobility is the nature of vehicles. When a vehicle UE moves within a mobile communication network, the mobile edge node serving the vehicle UE may be changed. Switching mobile edge node (which may include application relocation and context transfer) may be important to ensure service continuity and safety of ToD.

Current edge computing system may provide service discovery and service continuity support for a single UE. For instance, in a connected vehicle/autonomous vehicle system based on edge computing, the edge computing system may provide corresponding services to support a vehicle UE to switch edge node, e.g., as described in European telecommunication standards institute (ETSI) multi-access edge computing (MEC) “Application Mobility Service (AMS)”, or in the 3rd generation partnership project (3GPP) EDGEAPP “Service Continuity Support”.

However, in a ToD system, typically there are two kinds of UEs involved: a vehicle (as a primary UE) and a control station (as a secondary UE). The two UEs may need to communicate with the same EAS in order to exchange information. During edge node switching, the edge computing system may be required to coordinate the two UEs in order to ensure service continuity. Currently, there is no such kind of service continuity support provided by the edge computing system.

Various exemplary embodiments of the present disclosure propose a solution to coordinate a pair of UEs to select a common EAS to communicate with. Common EAS selection for the pair of UEs may be important for some use cases, such as TOD, remote drone control and digital twin, to avoid inter-EAS synchronization and reduce end-to-end latency. In accordance with an exemplary embodiment, a CAS may provide an edge discovery function for a secondary UE (e.g., a control station, etc.) to discover the common EAS. In accordance with another exemplary embodiment, an EAS may provide ACR support coordinating both a primary UE (e.g., a teleoperated vehicle, etc.) and a secondary UE (e.g., a control station, etc.).

It can be appreciated that although some exemplary embodiments are described in the context of ToD, the same principle may be applied to other use cases such as remote drone control and digital twin to enable common EAS selection for paired UEs, so as to avoid complex inter-EAS synchronization when two UEs connect to different EASs, and reduce the end-to-end latency for paired UE communication via the EAS.

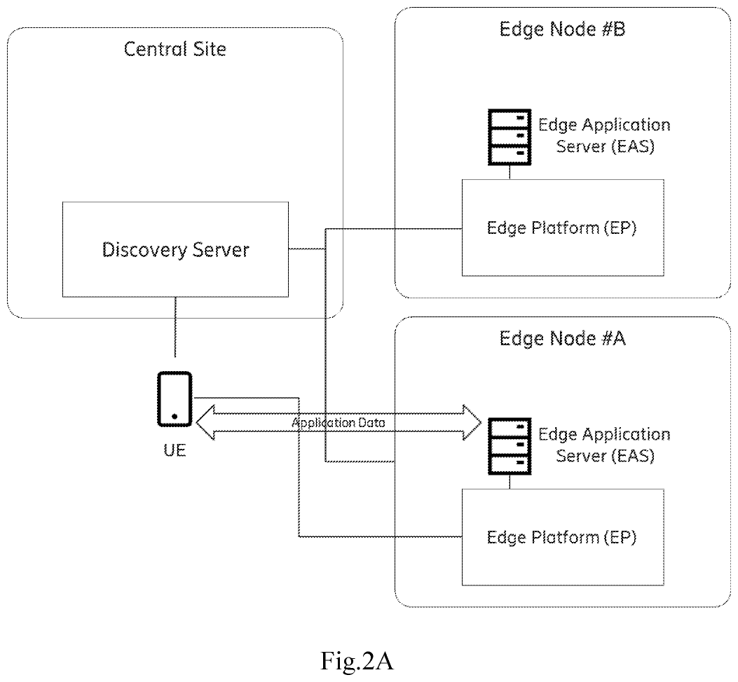

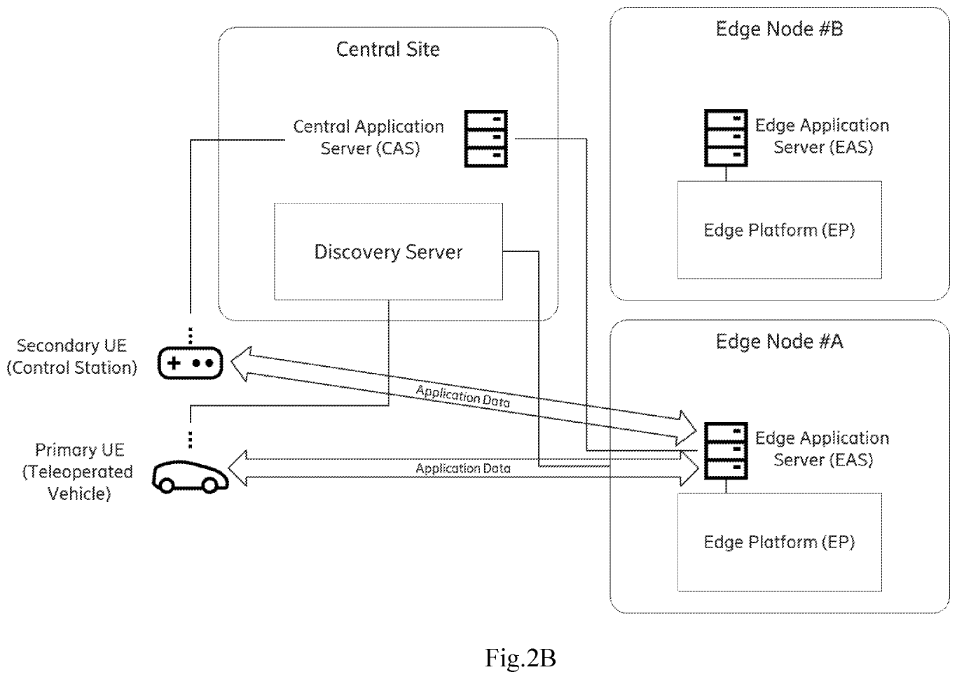

FIG. 2A is a diagram illustrating an exemplary architecture of an edge computing system according to an embodiment of the present disclosure. In the general reference architecture of the edge computing system, there may be one or more edge nodes (also called edge sites), such as edge node #A and edge node #B shown in FIG. 2A, each serving a corresponding geographical area. Each edge node may be connectable to a central node (also called central site) over a wired or wireless connection. In an edge node, a set of software and hardware may be deployed to serve UEs within a specific geographical area. Typically, the edge node may contain an EP providing a set of services and a virtualization infrastructure providing compute, storage and network resources for an EAS. The EP may provide a set of services to facilitate the EAS and a UE, such as EAS discovery, network capability and service continuity support, etc. In an embodiment, the EP may be mapped to an edge enabler server (EES) in 3GPP SA6 EDGEAPP (e.g., as described in 3GPP TS 23.558 V17.3.0, Technical Specification Group Services and System Aspects; Architecture for enabling Edge Applications), or an MEC Platform in ETSI MEC reference architecture (e.g., as described in ETSI GS MEC 003 V2.2.1, Multi-access Edge Computing; Framework and Reference Architecture).

In accordance with an exemplary embodiment, the EAS may be an application server developed by an application service provider (ASP) implementing specific business logic. The EAS may be deployed inside an edge node and can be accessed by a UE through an edge data network (EDN). In an embodiment, the EAS may be mapped to an EAS in 3GPP SA6 EDGEAPP (e.g., as described in 3GPP TS 23.558 V17.3.0, Technical Specification Group Services and System Aspects; Architecture for enabling Edge Applications), or an MEC Application in ETSI MEC reference architecture (e.g., as described in ETSI GS MEC 003 V2.2.1, Multi-access Edge Computing; Framework and Reference Architecture).

In accordance with an exemplary embodiment, at a central site, a discovery server may be deployed as a centralized server to provide a service for a UE to discover an edge node/edge site/edge platform based on the context of the UE. In an embodiment, the discovery server may be mapped to an edge configuration server (ECS) in 3GPP SA6 EDGEAPP (e.g., as described in 3GPP TS 23.558 V17.3.0, Technical Specification Group Services and System Aspects; Architecture for enabling Edge Applications).

FIG. 2B is a diagram illustrating an exemplary architecture of paired UEs communication using edge according to an embodiment of the present disclosure.

Various entities applicable to an edge computing system may be deployed in the architecture of paired UEs communication using edge. As shown in FIG. 2B, a CAS which is not deployed in edge but in central cloud may cooperate with an EAS. The CAS may also be developed by an ASP. A pair of UEs including a primary UE (e.g., a teleoperated vehicle, etc.) and a secondary UE (e.g., a control station, etc.) may be served by the edge computing system and communicate with each other via an EAS. In accordance with an exemplary embodiment, the primary UE may use the service provided by the edge computing system to discover an EP/EAS, and the EP/EAS may be selected according to the primary UE's context (e.g., location, etc.). The secondary UE may use the CAS to discover an EP/EAS, and the EP/EAS may be selected according to the paired primary UE. In an embodiment, the primary UE and the secondary UE may exchange application data through the same EAS instead of direct communication. Using the EAS to relay the paired UEs communication may have several advantages, such as data enrichment, security/privacy assurance and etc.

It can be appreciated that the system structure and various nodes/entities shown in FIG. 2A and FIG. 2B are just examples, and more or less alternative nodes/entities and the corresponding interfaces may be included in the edge computing system with different structures to support paired UEs communication according to embodiments of the present disclosure.

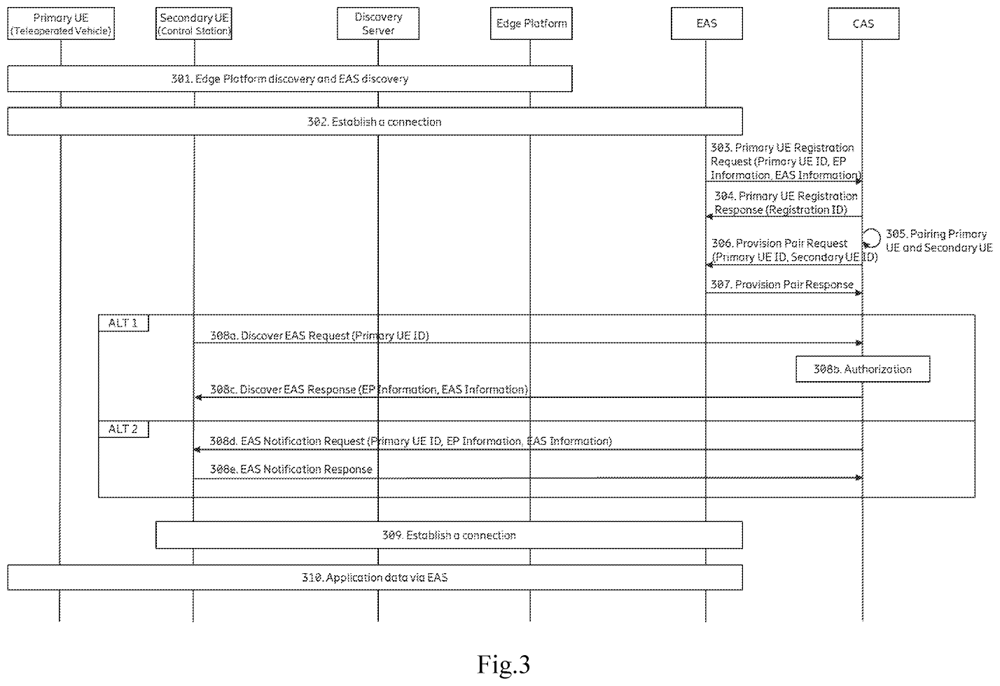

FIG. 3 is a diagram illustrating an exemplary edge discovery procedure according to an embodiment of the present disclosure. The edge discovery procedure may be performed for a pair of UEs, e.g., a primary UE (e.g., a teleoperated vehicle, etc.) and a secondary UE (e.g., a control station, etc.), to discover a common EAS to connect to when they start accessing to the services provided by the EAS. In accordance with an exemplary embodiment, when performing edge discovery for the paired UEs, the primary UE may use the service provided by an edge computing system to discover an EAS, while the secondary UE may use a CAS to discover the

EAS serving the primary UE. It can be appreciated that network elements and signaling messages shown in FIG. 3 are just examples, and more or less alternative network elements and signaling messages may be involved in the edge discovery procedure according to various embodiments of the present disclosure. As shown in FIG. 3, the edge discovery procedure may include the following operations:

301: A primary UE may discover an EAS through an edge computing system. For example, the primary UE may discover an EP through a discovery server, and discover/select the EAS through the EP.

302: The primary UE may establish a connection towards the discovered/selected EAS.

303: The EAS may send a ‘Primary UE Registration’ request to a CAS. The ‘Primary UE Registration’ request may include the primary UE ID and the information about the EP/EAS that the primary UE currently connects to. The EP/EAS information may at least contain ID and endpoint information.

304: The CAS may send a ‘Primary UE Registration’ response to the EAS with a registration ID.

305: The CAS may pair the primary UE and a secondary UE on demand.

306: The CAS may send a ‘Provision Pair’ request to the EAS that the primary UE currently connects to. The ‘Provision Pair’ request may include the primary UE ID and the secondary UE ID.

307: The EAS may send a ‘Provision Pair’ response back to the CAS.

308: The CAS may provide the EP/EAS information to the secondary UE. There may be two alternatives to pull/push the EP/EAS information from the CAS to the secondary UE:
Alternative 1 (ALT 1: Pull the EP/EAS information)

308a: The secondary UE may discover the EAS through the CAS if it knows the UE ID of the primary UE. For example, the secondary UE may send a ‘Discover EAS’ request to the CAS. The ‘Discover EAS’ request may include the primary UE ID.

308b: The CAS may perform authorization based on the pairing information about the primary UE and the secondary UE for security and privacy purpose.

308c: The CAS may send, to the secondary UE, a ‘Discover EAS’ response with the EP/EAS information indicating the EP/EAS to which the primary UE currently connects. The EP/EAS information may at least contain ID and endpoint information.
Alternative 2 (ALT 2: Push the EP/EAS information) 308d: The CAS may push the EP/EAS information to the secondary UE, e.g., by sending a ‘EAS Notification’ request. The ‘EAS Notification’ request may include the primary UE ID and the EP/EAS information.

308e: The secondary UE may send a ‘EAS Notification’ response back to the CAS.

309: The secondary UE may establish a connection towards the same EAS to which the primary UE currently connects.

310: The secondary UE may communicate with the primary UE via the EAS.

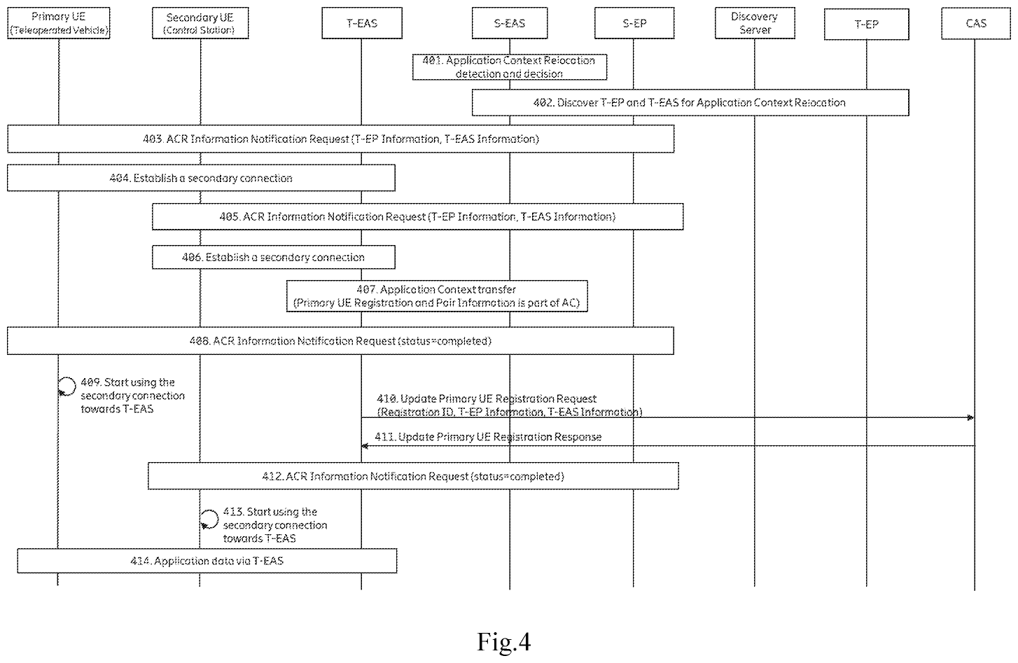

FIG. 4 is a diagram illustrating an exemplary ACR procedure according to an embodiment of the present disclosure. The ACR procedure may be triggered by the movement of a primary UE. When the primary UE switches its serving edge node, a source EAS (S-EAS) may need to transfer the application context of the paired UEs (a primary UE and a secondary UE) to a target EAS (T-EAS) to make sure that the T-EAS can serve the paired UEs without service interruption, which is also known as service continuity support. In accordance with an exemplary embodiment, in order to support service continuity, the secondary UE may be informed of the ACR status so that the secondary UE may connect to the same T-EAS as the primary UE. It can be appreciated that network elements and signaling messages shown in FIG. 4 are just examples, and more or less alternative network elements and signaling messages may be involved in the ACR procedure according to various embodiments of the present disclosure. As shown in FIG. 4, the ACR procedure may include the following operations:

401: An S-EAS may detect the need for a primary UE to switch edge node (e.g., through monitoring the location of the primary UE). Then the S-EAS may decide to trigger ACR.

402: The S-EAS may discover a T-EP and a T-EAS based on the context of the primary UE (e.g., its current location, etc.) by using the services provided by an edge computing system. For example, the S-EAS may discover the T-EP through a discovery server and discover the T-EAS through the T-EP.

403: The S-EAS may notify the primary UE about the T-EP/T-EAS information. In an embodiment, the S-EAS may send a ‘ACR Information Notification’ request to an S-EP. The ‘ACR Information Notification’ request sent to the S-EP may include the primary UE ID and the T-EP/T-EAS information. The T-EP/T-EAS information may at least contain ID and endpoint information. Then the S-EP may send a ‘ACR Information Notification’ request to the primary UE. The ‘ACR Information Notification’ request sent to the primary UE may include the T-EP/T-EAS information. The T-EP/T-EAS information may at least contain ID and endpoint information. Optionally, the primary UE may send a ‘ACR Information Notification’ response back to the S-EP, and the S-EP may send the ‘ACR Information Notification’ response back to the S-EAS.

404: The primary UE may establish a secondary connection toward the T-EAS.

405: Based on the pairing information about the primary UE and the secondary UE, the S-EAS may also notify the secondary UE about the T-EP/T-EAS information. In an embodiment, the S-EAS may send a ‘ACR Information Notification’ request to the S-EP. The ‘ACR Information Notification’ request sent to the S-EP may include the secondary UE ID and the T-EP/T-EAS information. The T-EP/T-EAS information may at least contain ID and endpoint information. Then the S-EP may send a ‘ACR Information Notification’ request to the secondary UE. The ‘ACR Information Notification’ request sent to the secondary UE may include the T-EP/T-EAS information. The T-EP/T-EAS information may at least contain ID and endpoint information. Optionally, the secondary UE may send a ‘ACR Information Notification’ response back to the S-EP, and the S-EP may send the ‘ACR Information Notification’ response back to the S-EAS.

406: The secondary UE may establish a secondary connection towards the T-EAS.

407: The S-EAS may start transferring the application context of the primary UE and the secondary UE to the T-EAS. In an embodiment, the primary UE's registration information (e.g., including a registration ID) and the pairing information (e.g., including the primary UE ID and the secondary UE ID) may be part of the application context so that the primary UE's registration information and the pairing information may also be transferred from the S-EAS to the T-EAS.

408: Once the application context transfer is completed, the S-EAS may notify the primary UE about the completed status, e.g., by sending another ‘ACR Information Notification’ request. For example, the S-EAS may send a ‘ACR Information Notification’ request to the S-EP. The ‘ACR Information Notification’ request sent to the S-EP may include the primary UE ID and the completed status. The S-EP may send a ‘ACR Information Notification’ request to the primary UE. The ‘ACR Information Notification’ request sent to the primary UE may include the completed status. Optionally, the primary UE may send a ‘ACR Information Notification’ response back to the S-EP, and the S-EP may send the ‘ACR Information Notification’ response back to the S-EAS.

409: The primary UE may start using the secondary connection towards the T-EAS.

410: The T-EAS may send an ‘Update Primary UE Registration’ request to the CAS. The ‘Update Primary UE Registration’ request may include a registration ID of the primary UE and the T-EP/T-EAS information.

411: The CAS may send an ‘Update Primary UE Registration’ response back to the T-EAS, e.g., when registration information of the primary UE is updated at the CAS.

412: Based on the pairing information, the S-EAS may also notify the secondary UE about the completed status. In an embodiment, the S-EAS may send a ‘ACR Information Notification’ request to the S-EP. The ‘ACR Information Notification’ request sent to the S-EP may include the secondary UE ID and the completed status. The S-EP may send a ‘ACR Information Notification’ request to the secondary UE. The ‘ACR Information Notification’ request sent to the secondary UE may include the completed status. Optionally, the secondary UE may send a ‘ACR Information Notification’ response back to the S-EP, and the S-EP may send the ‘ACR Information Notification’ response back to the S-EAS.

413: The secondary UE may start using the secondary connection towards the T-EAS.

414: The secondary UE may communicate with the primary UE via the T-EAS.

It can be appreciated that names, parameters and routing of various messages/signaling shown in FIG. 3 and FIG. 4 are just examples, and other alternative names, parameters and routing as well as associated configurations and settings of different messages/signaling may be applied in the implementations of the proposed solutions according to various embodiments of the present disclosure.

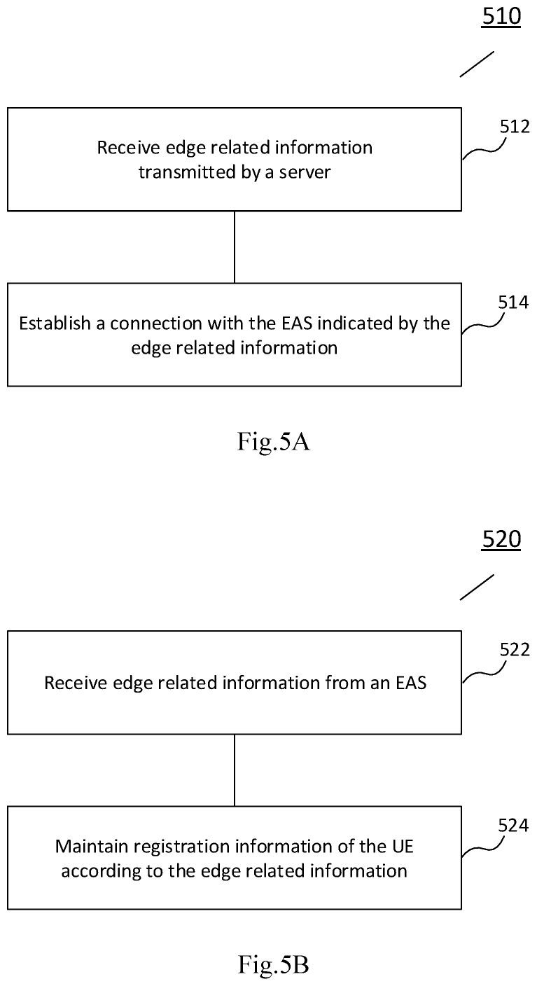

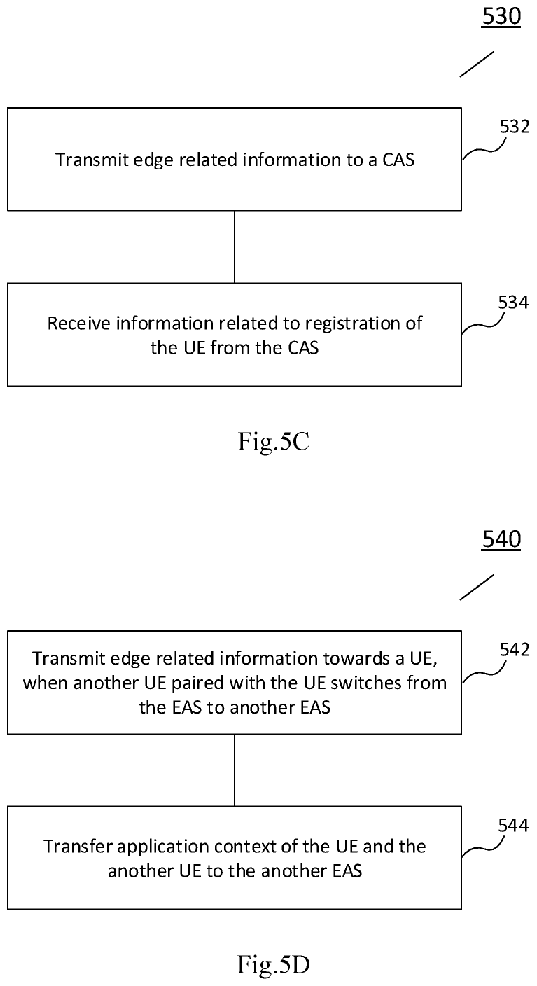

FIG. 5A is a flowchart illustrating a method 510 according to some embodiments of the present disclosure. The method 510 illustrated in FIG. 5A may be performed by a UE (e.g., a secondary UE such as a control station, etc.) or an apparatus communicatively coupled to the UE. In accordance with an exemplary embodiment, the UE may be configured to obtain various services provided by an application server (e.g., an EAS, a CAS, etc.) and communicate with another UE (e.g., a primary UE such as a teleoperated vehicle, etc.) in an edge computing system.

According to the exemplary method 510 illustrated in FIG. 5A, the UE may receive edge related information transmitted by a server, as shown in block 512. The edge related information may indicate an EAS which is serving or to serve another UE paired with the UE. In accordance with an exemplary embodiment, the UE may establish a connection with the EAS indicated by the edge related information, as shown in block 514.

In accordance with an exemplary embodiment, the edge related information may further indicate an EP associated with the EAS.

In accordance with an exemplary embodiment, the server may be a CAS.

In accordance with an exemplary embodiment, the UE may transmit a request (e.g., the ‘Discover EAS’ request in FIG. 3) for the edge related information to the CAS. The request may indicate the another UE (e.g., by including an ID of the another UE).

In accordance with an exemplary embodiment, the edge related information may further indicate the another UE (e.g., by including an ID of the another UE in the ‘EAS Notification’ request of FIG. 3).

In accordance with an exemplary embodiment, the UE may transmit a message (e.g., the ‘EAS Notification’ response in FIG. 3) to the CAS. The message may indicate that the edge related information is received by the UE.

In accordance with an exemplary embodiment, the server may be a source EAS (e.g., the S-EAS in FIG. 4) of the UE and the another UE, and the EAS indicated by the edge related information may be a target EAS (e.g., the T-EAS in FIG. 4) to which the UE and the another UE are to switch from the source EAS.

In accordance with an exemplary embodiment, the UE may receive a notification (e.g., the ‘ACR Information Notification’ request in FIG. 4) transmitted by the source EAS. The notification may indicate status of ACR of the UE and the another UE.

In accordance with an exemplary embodiment, the UE may use the established connection with the target EAS to communicate with the another UE, when the notification (e.g., the ‘ACR Information Notification’ request in FIG. 4) indicates that the ACR of the UE and the another UE is completed.

FIG. 5B is a flowchart illustrating a method 520 according to some embodiments of the present disclosure. The method 520 illustrated in FIG. 5B may be performed by a CAS or an apparatus communicatively coupled to the CAS. In accordance with an exemplary embodiment, the CAS may be configured to support or provision various services to one or more UEs. In accordance with another exemplary embodiment, the CAS may be configured to communicate with one or more other servers (e.g., one or more EASs, etc.) to implement application provision and/or management of one or more UEs.

According to the exemplary method 520 illustrated in FIG. 5B, the CAS may receive edge related information from an EAS, as shown in block 522. The edge related information may indicate that the EAS is serving or to serve a UE (e.g., a primary UE of paired UEs). In accordance with an exemplary embodiment, the CAS may maintain registration information of the UE according to the edge related information, as shown in block 524. The registration information of the UE may indicate a serving EAS of the UE.

In accordance with an exemplary embodiment, the edge related information may further indicate an EP associated with the EAS.

In accordance with an exemplary embodiment, the CAS may maintain the registration information of the UE according to the edge related information, by generating the registration information of the UE according to the edge related information. The registration information may include a registration ID of the UE. In an embodiment, the CAS may transmit the registration ID of the UE to the EAS (e.g., in the ‘Primary UE Registration’ response of FIG. 3).

In accordance with an exemplary embodiment, the CAS may pair the UE and another UE (e.g., a secondary UE of the paired UEs). In an embodiment, the CAS may transmit pairing information to the EAS (e.g., in the ‘Provision Pair’ request of FIG. 3). The pairing information may indicate the UE and the another UE.

In accordance with an exemplary embodiment, the CAS may transmit the edge related information to another UE paired with the UE (e.g., in the ‘Discover EAS’ response and/or the ‘EAS Notification’ request of FIG. 3).

In accordance with an exemplary embodiment, the CAS may receive a request (e.g., the ‘Discover EAS’ request in FIG. 3) for the edge related information from the another UE. The request may indicate the UE (e.g., by including an ID of the UE). In an embodiment, the edge related information may be transmitted to the another UE when the another UE is authorized by the CAS.

In accordance with an exemplary embodiment, the edge related information may further indicate the UE (e.g., by including an ID of the UE in the ‘EAS Notification’ request of FIG. 3). In an embodiment, the CAS may receive a message (e.g., the ‘EAS Notification’ response in FIG. 3) from the another UE. The message may indicate that the edge related information is received by the another UE.

In accordance with an exemplary embodiment, the EAS may be a target EAS (e.g., the T-EAS in FIG. 4) to which the UE is to switch from a source EAS (e.g., the S-EAS in FIG. 4), and the edge related information received by the CAS may include a registration ID of the UE.

In accordance with an exemplary embodiment, the CAS may maintain the registration information of the UE according to the edge related information, by updating the registration information of the UE via changing the serving EAS of the UE from the source EAS to the target EAS according to the registration identifier of the UE. In an embodiment, the CAS may inform the EAS of the update of the registration information of the UE (e.g., in the ‘Update Primary UE Registration’ response of FIG. 4).

FIG. 5C is a flowchart illustrating a method 530 according to some embodiments of the present disclosure. The method 530 illustrated in FIG. 5C may be performed by an EAS (e.g., the EAS shown in FIG. 3 and the T-EAS shown in FIG. 4) or an apparatus communicatively coupled to the EAS. In accordance with an exemplary embodiment, the EAS may be configured to support or provision various services to one or more UEs. In accordance with another exemplary embodiment, the EAS may be configured to communicate with one or more other servers (e.g., one or more other EASs, a CAS, etc.) to implement application provision and/or management of one or more UEs.

According to the exemplary method 530 illustrated in FIG. 5C, the EAS may transmit edge related information to a CAS, as shown in block 532. The edge related information may indicate that the EAS is serving or to serve a UE (e.g., a primary UE of paired UEs). In accordance with an exemplary embodiment, the EAS may receive information related to registration of the UE from the CAS, as shown in block 534.

In accordance with an exemplary embodiment, the edge related information may further indicate an EP associated with the EAS.

In accordance with an exemplary embodiment, the information related to the registration of the UE received by the EAS may include a registration ID of the UE (e.g., in the ‘Primary UE Registration’ response of FIG. 3).

In accordance with an exemplary embodiment, the EAS may receive pairing information from the CAS (e.g., in the ‘Provision Pair’ request of FIG. 3). The pairing information may indicate the UE and another UE (e.g., a secondary UE) paired with the UE.

In accordance with an exemplary embodiment, the EAS may be a target EAS (e.g., the T-EAS in FIG. 4) to which the UE is to switch from a source EAS (e.g., the S-EAS in FIG. 4), and the edge related information transmitted to the CAS by the EAS may include a registration ID of the UE.

In accordance with an exemplary embodiment, the EAS may receive application context of the UE and another UE (e.g., a secondary UE) paired with the UE from the source EAS. The application context may include the registration ID of the UE and/or pairing information which indicates the UE and the another UE.

In accordance with an exemplary embodiment, the information related to the registration of the UE received by the EAS from the CAS may indicate that registration information of the UE at the CAS is updated by changing a serving EAS of the UE to the target EAS.

In accordance with an exemplary embodiment, the EAS may establish a connection with the another UE, so as to support communication between the UE and the another UE.

FIG. 5D is a flowchart illustrating a method 540 according to some embodiments of the present disclosure. The method 540 illustrated in FIG. 5D may be performed by an EAS (e.g., the S-EAS shown in FIG. 4) or an apparatus communicatively coupled to the EAS. In accordance with an exemplary embodiment, the EAS may be configured to support or provision various services to one or more UEs. In accordance with another exemplary embodiment, the EAS may be configured to communicate with one or more other servers (e.g., one or more other EASs, a CAS, etc.) to implement application provision and/or management of one or more UEs.

According to the exemplary method 540 illustrated in FIG. 5D, the EAS may transmit edge related information towards a UE (e.g., a secondary UE of paired UEs), when another UE (e.g., a primary UE) paired with the UE switches from the EAS to another EAS, as shown in block 542. The edge related information may indicate that the another EAS is serving or to serve the another UE. In accordance with an exemplary embodiment, the EAS may transfer application context of the UE and the another UE to the another EAS, as shown in block 544. The application context may include: a registration ID of the another UE, and/or pairing information which indicates the UE and the another UE.

In accordance with an exemplary embodiment, the edge related information may further indicate an EP associated with the another EAS.

In accordance with an exemplary embodiment, the registration ID of the another UE may be provided by a CAS (e.g., in the ‘Primary UE Registration’ response of FIG. 3), when the another UE is registered to the CAS.

In accordance with an exemplary embodiment, the EAS may transmit a notification (e.g., the ‘ACR Information Notification’ request in FIG. 4) towards the UE. The notification may indicate status of ACR of the UE and the another UE.

The various blocks shown in FIGS. 5A-5D may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

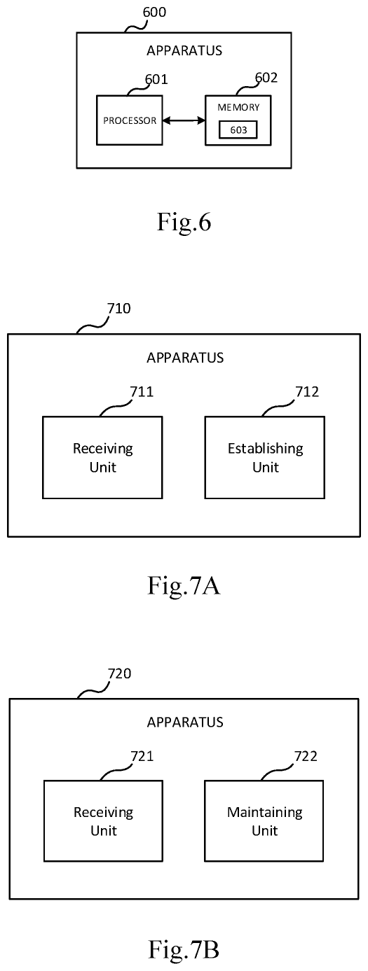

FIG. 6 is a block diagram illustrating an apparatus 600 according to various embodiments of the present disclosure. As shown in FIG. 6, the apparatus 600 may comprise one or more processors such as processor 601 and one or more memories such as memory 602 storing computer program codes 603. The memory 602 may be non-transitory machine/processor/computer readable storage medium. In accordance with some exemplary embodiments, the apparatus 600 may be implemented as an integrated circuit chip or module that can be plugged or installed into a UE as described with respect to FIG. 5A, or a CAS as described with respect to FIG. 5B, or an EAS as described with respect to FIG. 5C, or an EAS as described with respect to FIG. 5D. In such cases, the apparatus 600 may be implemented as a UE as described with respect to FIG. 5A, or a CAS as described with respect to FIG. 5B, or an EAS as described with respect to FIG. 5C, or an EAS as described with respect to FIG. 5D.

In some implementations, the one or more memories 602 and the computer program codes 603 may be configured to, with the one or more processors 601, cause the apparatus 600 at least to perform any operation of the method as described in connection with FIG. 5A. In other implementations, the one or more memories 602 and the computer program codes 603 may be configured to, with the one or more processors 601, cause the apparatus 600 at least to perform any operation of the method as described in connection with FIG. 5B. In other implementations, the one or more memories 602 and the computer program codes 603 may be configured to, with the one or more processors 601, cause the apparatus 600 at least to perform any operation of the method as described in connection with FIG. 5C. In other implementations, the one or more memories 602 and the computer program codes 603 may be configured to, with the one or more processors 601, cause the apparatus 600 at least to perform any operation of the method as described in connection with FIG. 5D. Alternatively or additionally, the one or more memories 602 and the computer program codes 603 may be configured to, with the one or more processors 601, cause the apparatus 600 at least to perform more or less operations to implement the proposed methods according to the exemplary embodiments of the present disclosure.

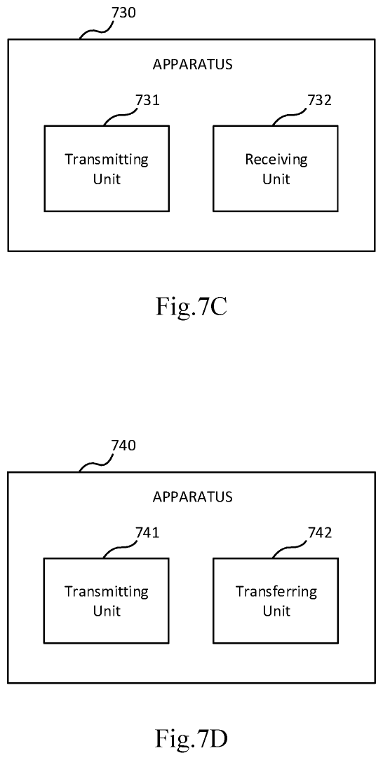

FIG. 7A is a block diagram illustrating an apparatus 710 according to some embodiments of the present disclosure. As shown in FIG. 7A, the apparatus 710 may comprise a receiving unit 711 and an establishing unit 712. In an exemplary embodiment, the apparatus 710 may be implemented in a UE. The receiving unit 711 may be operable to carry out the operation in block 512, and the establishing unit 712 may be operable to carry out the operation in block 514. Optionally, the receiving unit 711 and/or the establishing unit 712 may be operable to carry out more or less operations to implement the proposed methods according to the exemplary embodiments of the present disclosure. In an embodiment, the apparatus 710 may comprise a transmitting unit (not shown in FIG. 7A) for transmitting various kinds of information from the apparatus 710 to other devices (e.g., a UE, an EAS, a CAS, etc.).

FIG. 7B is a block diagram illustrating an apparatus 720 according to some embodiments of the present disclosure. As shown in FIG. 7B, the apparatus 720 may comprise a receiving unit 721 and a maintaining unit 722. In an exemplary embodiment, the apparatus 720 may be implemented in a CAS. The receiving unit 721 may be operable to carry out the operation in block 522, and the maintaining unit 722 may be operable to carry out the operation in block 524. Optionally, the receiving unit 721 and/or the maintaining unit 722 may be operable to carry out more or less operations to implement the proposed methods according to the exemplary embodiments of the present disclosure. In an embodiment, the apparatus 720 may comprise a transmitting unit (not shown in FIG. 7B) for transmitting various kinds of information from the apparatus 720 to other devices (e.g., a UE, an EAS, etc.).

FIG. 7C is a block diagram illustrating an apparatus 730 according to some embodiments of the present disclosure. As shown in FIG. 7C, the apparatus 730 may comprise a transmitting unit 731 and a receiving unit 732. In an exemplary embodiment, the apparatus 730 may be implemented in an EAS. The transmitting unit 731 may be operable to carry out the operation in block 532, and the receiving unit 732 may be operable to carry out the operation in block 534. Optionally, the transmitting unit 731 and/or the receiving unit 732 may be operable to carry out more or less operations to implement the proposed methods according to the exemplary embodiments of the present disclosure.

FIG. 7D is a block diagram illustrating an apparatus 740 according to some embodiments of the present disclosure. As shown in FIG. 7D, the apparatus 740 may comprise a transmitting unit 741 and a transferring unit 742. In an exemplary embodiment, the apparatus 740 may be implemented in an EAS. The transmitting unit 741 may be operable to carry out the operation in block 542, and the transferring unit 742 may be operable to carry out the operation in block 544. Optionally, the transmitting unit 741 and/or the transferring unit 742 may be operable to carry out more or less operations to implement the proposed methods according to the exemplary embodiments of the present disclosure. In an embodiment, the apparatus 740 may comprise a receiving unit (not shown in FIG. 7D) for receiving various kinds of information from other devices (e.g., a UE, an EAS, a CAS, etc.) to the apparatus 740.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a user equipment, UE, the method comprising:
receiving edge related information transmitted by a server, the edge related information indicating an edge application server, EAS, which is serving or to serve another UE paired with the UE; and
establishing a connection with the EAS indicated by the edge related information.

2. The method according to claim 1, wherein the edge related information further indicates an edge platform, EP, associated with the EAS.

3. The method according to claim 1, wherein the server is a central application server, CAS.

4. The method according to claim 3, further comprising:
transmitting a request for the edge related information to the CAS, wherein the request indicates the another UE.

5. The method according to claim 3, wherein the edge related information further indicates the another UE.

6. The method according to claim 5, further comprising:
transmitting a message to the CAS, wherein the message indicates that the edge related information is received by the UE.

7. The method according to claim 1, wherein the server is a source EAS of the UE and the another UE, and the EAS indicated by the edge related information is a target EAS to which the UE and the another UE are to switch from the source EAS.

8.-13. (canceled)

14. A method performed by a central application server, CAS, the method comprising:
receiving edge related information from an edge application server, EAS, the edge related information indicating that the EAS is serving or to serve a user equipment, UE; and
maintaining registration information of the UE according to the edge related information, wherein the registration information of the UE indicates a serving EAS of the UE.

15. The method according to claim 14, wherein the edge related information further indicates an edge platform, EP, associated with the EAS.

16. The method according to claim 14, wherein maintaining the registration information of the UE according to the edge related information comprises:
generating the registration information of the UE according to the edge related information, wherein the registration information includes a registration identifier of the UE.

17. The method according to claim 16, further comprises:
transmitting the registration identifier of the UE to the EAS.

18. The method according to claim 14, further comprising:
pairing the UE and another UE; and
transmitting pairing information to the EAS, wherein the pairing information indicates the UE and the another UE.

19. The method according to claim 14, further comprising:
transmitting the edge related information to another UE paired with the UE.

20.-29. (canceled)

30. A method performed by an edge application server, EAS, the method comprising:
transmitting edge related information to a central application server, CAS, the edge related information indicating that the EAS is serving or to serve a user equipment, UE; and
receiving information related to registration of the UE from the CAS.

31. The method according to claim 30, wherein the edge related information further indicates an edge platform, EP, associated with the EAS.

32. The method according to claim 30, wherein the information related to the registration of the UE includes a registration identifier of the UE.

33. The method according to claim 30, further comprising:
receiving pairing information from the CAS, wherein the pairing information indicates the UE and another UE paired with the UE.

34.-40. (canceled)

41. A method performed by an edge application server, EAS, the method comprising:
transmitting edge related information towards a user equipment, UE, when another UE paired with the UE switches from the EAS to another EAS, the edge related information indicating that the another EAS is serving or to serve the another UE; and
transferring application context of the UE and the another UE to the another EAS, the application context including one or both of:
a registration identifier of the another UE; and
pairing information which indicates the UE and the another UE.

42. The method according to claim 41, wherein the edge related information further indicates an edge platform, EP, associated with the another EAS.

43. The method according to claim 41, wherein the registration identifier of the another UE is provided by a central application server, CAS, when the another UE is registered to the CAS.

44.-47. (canceled)
